(19) United States
(12) Patent Application Publication
(10) Pub. No.: US 2026/0112293 A1
(43) Pub. Date: Apr. 23, 2026

(54) DENTAL SKILL TRAINING DEVICE

(71) Applicant: TOHOKU UNIVERSITY, Sendai-shi (JP)

(72) Inventor: Takeyoshi KOSEKI, Sendai-shi (JP)

(73) Assignee: TOHOKU UNIVERSITY, Sendai-shi (JP)

(21) Appl. No.: 19/338,041

(22) Filed: Sep. 24, 2025

(30) Foreign Application Priority Data
Oct. 23, 2024 (JP) 2024-187037

(51) Int. Cl. G09B 23/28; G01D 5/241

(52) U.S. Cl. CPC G09B 23/283; G01D 5/241

(57) ABSTRACT

A dental skill training device that trains a skill in using a needle instrument in dentistry, the needle instrument including a holding portion to be held by a user and a needle-shaped needle portion extending from a tip of the holding portion, includes: a tooth model simulating at least one tooth; and a contact detector configured to detect contact between the needle portion and a predetermined detection region of at least a part of a surface of the tooth.

### CROSS-REFERENCE TO THE RELATED APPLICATION

This application claims priority under 35 U.S.C. 119 from Japanese Patent Application No. 2024-187037, filed on Oct. 23, 2024, the contents of which are incorporated by reference herein.

### TECHNICAL FIELD

The present disclosure relates to a dental skill training device.

### BACKGROUND

A dental skill training device is known for training a skill in using a needle instrument in dentistry, the needle instrument including a holding portion to be held by a user and a needle-shaped needle portion extending from a tip of the holding portion. For example, a dental skill training device described in JP2017-74296A includes a sensor unit that has a pressure receiving surface against which a tip of a needle portion is pressed, and that measures a force applied from the needle portion to the pressure receiving surface. The needle instrument is a periodontal probe for measuring a depth of a periodontal pocket.

### SUMMARY

As shown in FIGS. 1A and 1B, a crown portion CR of a tooth TH bulges in a direction orthogonal to a tooth axis. The tooth axis is a central axis of the tooth TH extending from a root of the tooth TH to a tip of the tooth TH. Therefore, as shown in FIG. 1A, a portion of a needle portion ND other than a tip portion is likely to come into contact with a surface of the crown portion CR of the tooth TH. In this case, since the tip portion of the needle portion ND does not reach a bottom of the periodontal pocket, the depth of the periodontal pocket cannot be measured with high accuracy.

On the other hand, as shown in FIG. 1B, when the tip portion of the needle portion ND comes into contact with a surface of a tooth root portion RT of the tooth TH, the tip portion of the needle portion ND reaches the bottom of the periodontal pocket, so that the depth of the periodontal pocket can be measured with high accuracy.

As described above, in the dental skill training device, the force applied from the needle portion to the pressure receiving surface is measured. Therefore, it is possible to perform training for setting the force with which the needle portion presses the gum to an appropriate magnitude.

However, the dental skill training device described above has a problem in that a user cannot be trained to bring the needle portion of the needle instrument into contact with a specific region on the surface of the tooth. This type of problem may similarly occur when the needle instrument is a needle instrument other than the periodontal probe (for example, a scaler or an explorer).

An object of the disclosure is to allow a user to be trained to bring a needle portion of a needle instrument to come into contact with a specific region on a surface of a tooth.

In one aspect, a dental skill training device is a device for training a skill in using a needle instrument in dentistry, the needle instrument having a holding portion to be held by a user and a needle-shaped needle portion extending from a tip of the holding portion.

The dental skill training device includes a tooth model that simulates at least one tooth, and a contact detection unit that detects contact between the needle portion and a predetermined detection region of at least a part of the surface of the tooth.

The user can be trained to bring the needle portion of the needle instrument into contact with a specific region of the surface of the tooth.

### BRIEF DESCRIPTION OF THE DRAWINGS

FIGS. 1A and 1B are diagrams conceptually showing a position where a needle portion of a periodontal probe is in contact with a tooth;

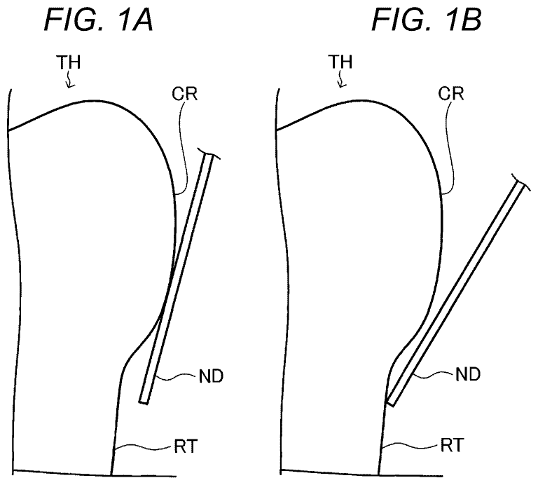

FIG. 2 is a diagram showing a configuration of a dental skill training system according to a first embodiment;

FIGS. 3A and 3B are front views of a tooth model according to the first embodiment;

FIG. 4 is a diagram showing a configuration of a dental skill training system according to a first modification of the first embodiment;

FIG. 5 is a diagram showing a configuration of a dental skill training system according to a second modification of the first embodiment;

FIG. 6 is a diagram showing a configuration of a dental skill training system according to a third modification of the first embodiment; and

FIG. 7 is a diagram showing a configuration of a dental skill training system according to a second embodiment.

### DESCRIPTION OF EMBODIMENTS

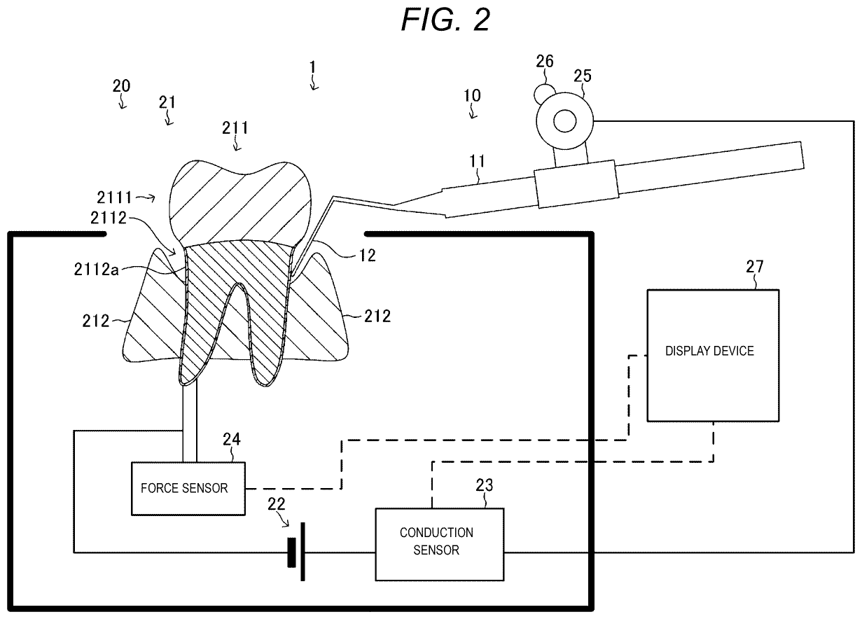

Hereinafter, embodiments of a dental skill training device according to the disclosure will be described with reference to FIGS. 2 to 7.

### First Embodiment

### Summary

A dental skill training device according to a first embodiment is a device for training a skill in using a needle instrument in dentistry, the needle instrument having a holding portion to be held by a user and a needle-shaped needle portion extending from a tip of the holding portion.

The dental skill training device includes a tooth model that simulates at least one tooth, and a contact detection unit. The contact detection unit detects contact between the needle portion and a predetermined detection region of at least a part of a surface of the tooth.

According to this, the contact between the needle portion of the needle instrument and the detection region of the surface of the tooth is detected. Accordingly, the user can be trained to bring the needle portion of the needle instrument into contact with a specific region of the surface of the tooth.

### Configuration

As shown in FIG. 2, a dental skill training system 1 of the first embodiment includes a periodontal probe 10 and a dental skill training device 20. The dental skill training system 1 is used to train the skill in using the periodontal probe 10 in dentistry.

The periodontal probe 10 is a needle instrument used in dentistry. The periodontal probe 10 is used to measure a depth of a periodontal pocket.

The periodontal probe 10 is made of a conductive material. In this example, the periodontal probe 10 is made of metal (for example, stainless steel). The periodontal probe 10 has a rod shape. The periodontal probe 10 includes a holding portion 11 and a needle portion 12. The holding portion 11 is to be held by a user. The needle portion 12 has a needle shape that extends from a tip of the holding portion 11 and is bent at an intermediate portion.

The needle portion 12 has a scale (not shown) at a tip portion. For example, the scale is constituted by scale lines or a stripe pattern.

The dental skill training system 1 may include a needle instrument (for example, a scaler or an explorer) different from the periodontal probe 10 instead of the periodontal probe 10.

The dental skill training device 20 includes a tooth model 21, a DC voltage source 22, a conduction sensor 23, a force sensor 24, a connector 25, a light source 26, and a display device 27. The dental skill training device 20 may not include the light source 26. The dental skill training device 20 may not include the display device 27.

In this example, the tooth model 21 includes a tooth 211 that simulates a human tooth and a gum 212 that simulates a human gum.

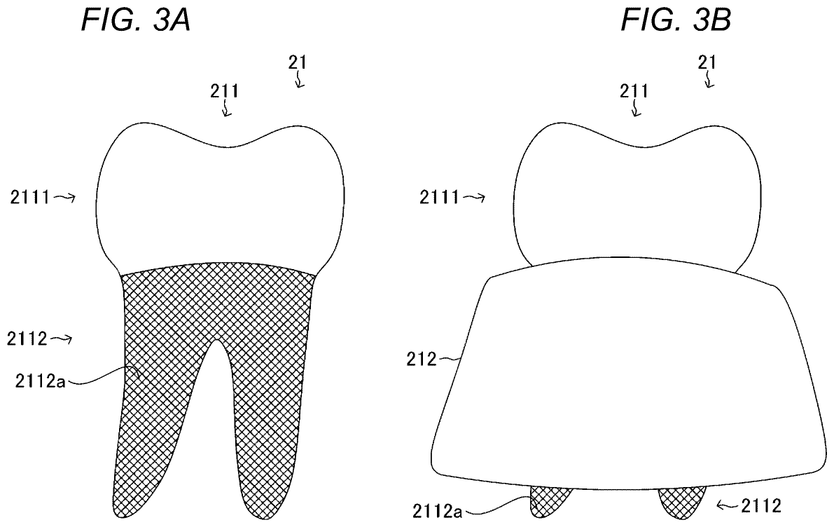

FIG. 2 shows a cross section of the tooth model 21. FIG. 3A is a front view of the tooth 211 in a state where the gum 212 is removed. FIG. 3B is a front view of the tooth model 21.

In this example, the tooth model 21 simulates a set of tooth and gum. The tooth model 21 may simulate two or more sets of teeth and gums. The tooth model 21 may not include the gum 212. Also in this case, the tooth model 21 may simulate two or more teeth.

The tooth 211 includes a crown portion 2111 and a tooth root portion 2112.

The crown portion 2111 is a portion of the tooth 211 closer to a tip of the tooth 211 in a direction along a tooth axis. The tooth axis is a central axis of the tooth 211 extending from a root of the tooth 211 to the tip of the tooth 211. The crown portion 2111 bulges in a direction orthogonal to the tooth axis.

The tooth root portion 2112 is a portion of the tooth 211 closer to the root of the tooth 211 in the direction along the tooth axis. The tooth root portion 2112 includes a conductive film 2112a. The conductive film 2112a is made of a conductive material. In this example, the conductive film 2112a is made of a conductive coating material. For example, the conductive film 2112a may be formed by coating using a spray.

For example, the conductive coating material may be a dispersion type in which a conductive additive (in other words, a filler) is dispersed in a coating material containing a resin as a main component, or may be an intrinsic type formed of a coating material containing a conductive polymer as a main component.

The conductive film 2112a constitutes a surface of the tooth root portion 2112. In this example, a portion of the tooth 211 other than the conductive film 2112a is made of a non-conductive material. For example, a portion of the tooth 211 other than the conductive film 2112a may be made of a resin called “resin”or a material containing ceramic as a main component.

The tooth root portion 2112 may be made of a conductive material (for example, a metal such as silver or a conductive resin). In this case, the tooth root portion 2112 may not include the conductive film 2112a.

The tooth root portion 2112 is embedded in the gum 212 so as to cover a center portion of the tooth root portion 2112 in the direction along the tooth axis. In other words, both end portions of the tooth root portion 2112 in the direction along the tooth axis are exposed. The end portions of the tooth root portion 2112 closer to the root of the tooth 211 in the direction along the tooth axis may be covered with the gum 212.

The gum 212 has a protrusion that protrudes toward the tip of the tooth 211 in the direction along the tooth axis at a position separated from the tooth root portion 2112 in the direction orthogonal to the tooth axis so as to simulate a periodontal pocket.

The gum 212 is made of a non-conductive material. In this example, the gum 212 is made of a non-conductive resin (for example, silicon resin).

In this example, a portion of the conductive film 2112a not covered with the gum 212 (in other words, an exposed portion) corresponds to the detection region.

The DC voltage source 22 has two terminals having different potentials. One terminal of the DC voltage source 22 is electrically connected to the conductive film 2112a. In this example, one terminal of the DC voltage source 22 is electrically connected to the conductive film 2112a via a support column of the force sensor 24 described later. One terminal of the DC voltage source 22 may be electrically connected directly to the conductive film 2112a.

The other terminal of the DC voltage source 22 is electrically connected to the conduction sensor 23.

The force sensor 24 supports the tooth model 21 via the support column. In this example, the support column has conductivity. The force sensor 24 detects a force applied from the periodontal probe 10 to the tooth model 21 in each of three axial directions orthogonal to one another. The force sensor 24 outputs force information representing the force detected in each of the three axial directions to the display device 27.

In this example, the force sensor 24 corresponds to a force detection unit.

The connector 25 is fixed to the holding portion 11 of the periodontal probe 10. The connector 25 is made of a conductive material. In this example, the connector 25 is made of metal (for example, stainless steel). In this example, the connector 25 is a clip that clamps the holding portion 11. The connector 25 is electrically connected to the conduction sensor 23.

With such a configuration, an electric circuit becomes a closed circuit in a state where the needle portion 12 of the periodontal probe 10 is in contact with the conductive film 2112a of the tooth root portion 2112. In this example, the electric circuit is formed by electrically connecting the periodontal probe 10, the conductive film 2112a, the DC voltage source 22, the conduction sensor 23, and the connector 25. Accordingly, a current flows through the conduction sensor 23. In this manner, the dental skill training device 20 detects contact between the detection region and the needle portion 12 by detecting conduction between the detection region and the needle portion 12.

On the other hand, the electric circuit becomes an open circuit in a state where the needle portion 12 of the periodontal probe 10 is separated from the conductive film 2112a of the tooth root portion 2112. Accordingly, no current flows through the conduction sensor 23.

The conduction sensor 23 detects that a current is flowing through the conduction sensor 23. For example, the conduction sensor 23 may be a current sensor of a resistance detection type or a magnetic field detection type. The conduction sensor 23 outputs conduction information indicating whether a current flows through the conduction sensor 23 to the display device 27.

In the present example, the conductive film 2112a, the DC voltage source 22, the conduction sensor 23, and the connector 25 correspond to the contact detection unit.

The light source 26 is fixed to the connector 25. The light source 26 emits light when a current flows through the connector 25. In this example, the light source 26 is a light emitting diode (LED). With such a configuration, the light source 26 emits light when the contact between the detection region and the needle portion 12 is detected. In this example, the light source 26 corresponds to a notification unit.

The display device 27 includes a display and a speaker. In this example, the display device 27 is an information processing device (in other words, a computer). For example, the display device 27 may be a desktop computer, a laptop computer, a tablet computer, a smartphone, a game machine, a television receiver, or smart glasses. The display device 27 may include a plurality of devices communicably connected to one another.

The display device 27 displays the force information output by the force sensor 24 on the display. For example, the display device 27 may display the force information three-dimensionally, or may display the force information in a virtual reality (VR) space.

When the force information output from the force sensor 24 indicates that a magnitude of the force applied from the periodontal probe 10 to the tooth model 21 exceeds a first threshold, the display device 27 emits a first warning sound from the speaker. For example, the first threshold is 0.25 [N]. For example, the first warning sound is a sound of a telephone ringing.

Further, when the force information output from the force sensor 24 indicates that the magnitude of the force applied from the periodontal probe 10 to the tooth model 21 exceeds a second threshold larger than the first threshold, the display device 27 emits a second warning sound from the speaker. For example, the second threshold is 0.50 [N]. For example, the second warning sound is a whistle sound. The second warning sound may include a sound of a machine gun instead of or in addition to the whistle sound.

The display device 27 may use a magnitude of a component of the force applied from the periodontal probe 10 to the tooth model 21 in a predetermined detection direction, instead of the magnitude of the force applied from the periodontal probe 10 to the tooth model 21.

Further, the display device 27 displays the conduction information output by the conduction sensor 23 on the display.

### Operation

Next, operations of the dental skill training system 1 according to the first embodiment will be described.

The user holds the holding portion 11 of the periodontal probe 10 by a hand wearing a non-conductive glove. At this time, the needle portion 12 of the periodontal probe 10 is separated from the conductive film 2112a of the tooth root portion 2112. Therefore, the electric circuit is the open circuit. Therefore, since no current flows through the conduction sensor 23, the light source 26 does not emit light.

Thereafter, the user operates the periodontal probe 10, so that the tip of the needle portion 12 comes into contact with the tooth root portion 2112 at a bottom of the periodontal pocket. Accordingly, the needle portion 12 of the periodontal probe 10 comes into contact with the conductive film 2112a of the tooth root portion 2112. Therefore, the electric circuit becomes the closed circuit. Therefore, since a current flows through the conduction sensor 23, the light source 26 emits light.

Further, when the magnitude of the force applied from the periodontal probe 10 to the tooth model 21 exceeds the first threshold, the display device 27 emits the first warning sound from the speaker. Further, when the magnitude of the force applied from the periodontal probe 10 to the tooth model 21 exceeds the second threshold, the display device 27 emits the second warning sound from the speaker.

In this manner, the user gains training of the skill in using the periodontal probe 10 in dentistry.

As described above, the dental skill training device 20 of the first embodiment is used to train the skill in using the needle instrument (in this example, the periodontal probe 10) in dentistry, the needle instrument having the holding portion 11 to be held by the user and the needle-shaped needle portion 12 extending from the tip of the holding portion 11.

The dental skill training device 20 includes the tooth model 21 and the contact detection unit (in this example, the conductive film 2112a, the DC voltage source 22, the conduction sensor 23, and the connector 25). The tooth model 21 simulates at least one tooth.

The contact detection unit detects the contact between the needle portion 12 and the predetermined detection region (in this example, a portion of the conductive film 2112a that is not covered with the gum 212) of at least a part of the surface of the tooth 211.

According to this, the contact between the needle portion 12 of the needle instrument and the detection region of the surface of the tooth 211 is detected. Accordingly, the user can be trained to bring the needle portion 12 of the needle instrument into contact with the specific region of the surface of the tooth 211.

Further, in the dental skill training device 20 of the first embodiment, the detection region and the needle portion 12 have conductivity. The contact detection unit detects the contact by detecting the conduction between the detection region and the needle portion 12.

According to this, it is possible to easily detect the contact between the needle portion 12 of the needle instrument and the detection region of the surface of the tooth 211.

Further, in the dental skill training device 20 of the first embodiment, the detection region is the surface of the tooth root portion 2112 of the tooth 211. A portion of the surface of the tooth 211 other than the detection region does not have conductivity.

According to this, the contact between the needle portion 12 of the needle instrument and the surface of the tooth root portion 2112 of the tooth 211 is detected. Accordingly, the user can be trained to bring the needle portion 12 of the needle instrument into contact with the surface of the tooth root portion 2112 of the tooth 211. As a result, when the needle instrument is the periodontal probe 10 as in this example, the user can measure a depth of the periodontal pocket with high accuracy.

Further, the dental skill training device 20 of the first embodiment includes the force detection unit (in this example, the force sensor 24) that detects a force applied to the tooth model 21.

According to this, the force with which the needle portion 12 of the needle instrument presses the tooth model 21 is detected. Accordingly, it is possible to detect that the needle portion 12 of the needle instrument is in contact with a region of the surface of the tooth 211 other than the detection region. In addition, it is possible to perform training for setting the force with which the needle portion 12 of the needle instrument presses the tooth 211 or the gum 212 to an appropriate magnitude.

Further, the dental skill training device 20 of the first embodiment includes the notification unit (the light source 26 in this example) that emits at least one of a sound and light when the contact between the detection region and the needle portion 12 is detected.

According to this, it is possible to cause the user to recognize the contact between the needle portion 12 of the needle instrument and the specific region of the surface of the tooth 211.

When the contact between the detection region and the needle portion 12 is detected, the dental skill training device 20 may emit a sound instead of or in addition to light. In addition, the dental skill training device 20 may continue to emit a sound (for example, music) during the training, and may change a volume of the emitted sound between a state in which the detection region and the needle portion 12 are not in contact with each other and a state in which the detection region and the needle portion 12 are in contact with each other.

In the dental skill training device 20 of the first embodiment, the conductive film 2112a constitutes the entire surface of the tooth root portion 2112. The conductive film 2112a may constitute only a part of the surface of the tooth root portion 2112 (for example, a region in the vicinity of the bottom of the periodontal pocket). The conductive film 2112a may constitute a surface of the crown portion 2111 in addition to the tooth root portion 2112. In other words, the conductive film 2112a may constitute the entire surface of the tooth 211.

In the periodontal probe 10 of the first embodiment, the entire needle portion 12 has conductivity. The periodontal probe 10 may be configured such that the surface of the portion of the needle portion 12 other than the tip portion does not have conductivity.

According to this, the contact between the surface of the portion of the needle portion 12 of the needle instrument other than the tip portion and the surface of the tooth 211 is not detected. Accordingly, the user can be trained to bring the tip portion of the needle portion 12 of the needle instrument into contact with the specific region of the surface of the tooth 211. As a result, when the needle instrument is the periodontal probe 10 as in this example, the user can measure the depth of the periodontal pocket with high accuracy.

### First Modification of First Embodiment

Next, a dental skill training device according to a first modification of the first embodiment will be described. The dental skill training device according to the first modification of the first embodiment is different from the dental skill training device according to the first embodiment in that an imaging unit is provided. Hereinafter, the difference will be mainly described. In the description of the first modification of the first embodiment, the same reference numerals as those used in the first embodiment are the same or substantially the same.

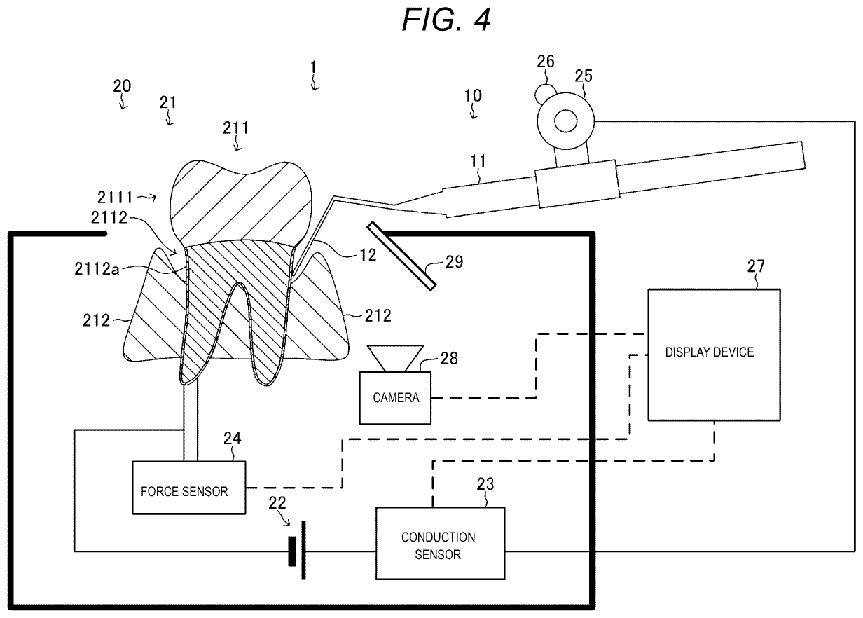

As shown in FIG. 4, the dental skill training device 20 according to the first modification of the first embodiment includes a camera 28 and a mirror 29 in addition to the configuration of the dental skill training device 20 according to the first embodiment.

The camera 28 generates a moving image by imaging an imaging region including a boundary between the crown portion 2111 and the tooth root portion 2112 on the surface of the tooth 211 via the mirror 29. In this example, the camera 28 and the mirror 29 correspond to the imaging unit. When the camera 28 can directly image the imaging region, the dental skill training device 20 may not include the mirror 29.

The camera 28 outputs the generated moving image to the display device 27. The display device 27 displays the moving image output by the camera 28 on the display.

In this example, the tooth model 21 simulates a set of tooth and gum. In this example, the gum is made of a transparent material. The tooth model 21 may simulate two or more sets of teeth and gums. The tooth model 21 may not include the gum 212. Also in this case, the tooth model 21 may simulate two or more teeth.

As described above, according to the dental skill training device 20 of the first modification of the first embodiment, the same operations and effects as those of the dental skill training device 20 of the first embodiment are achieved.

Further, the dental skill training device 20 according to the first modification of the first embodiment includes the imaging unit (in this example, the camera 28 and the mirror 29) that images the imaging region including the boundary between the crown portion 2111 and the tooth root portion 2112 on the surface of the tooth 211.

According to this, it is possible to cause the user to recognize a position and operation of the needle instrument together with the presence or absence of the contact between the needle portion 12 of the needle instrument and the specific region of the surface of the tooth 211.

### Second Modification of First Embodiment

Next, a dental skill training device according to a second modification of the first embodiment will be described. The dental skill training device according to the second modification of the first embodiment is different from the dental skill training device according to the first embodiment in that the force sensor is not provided. Hereinafter, the difference will be mainly described. In the description of the second modification of the first embodiment, the same reference numerals as those used in the first embodiment are the same or substantially the same.

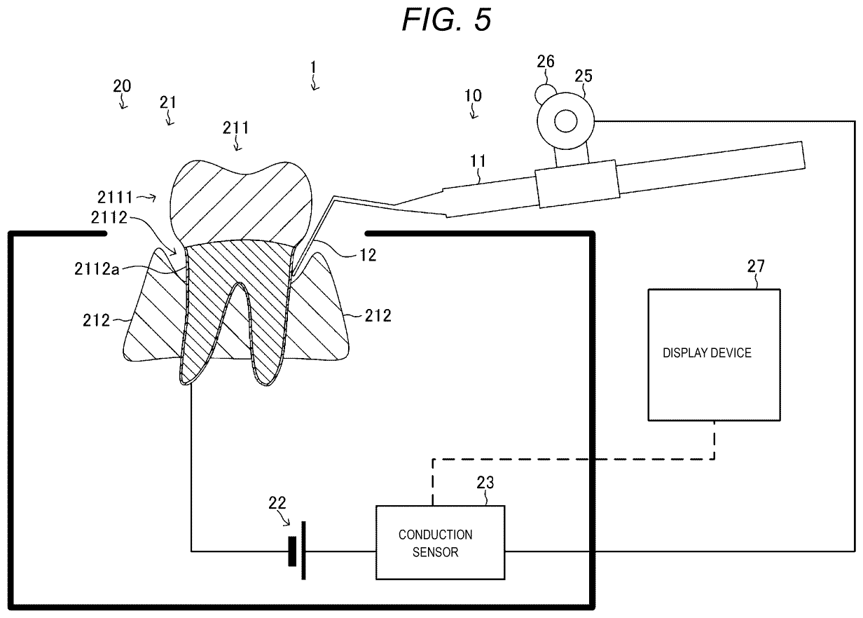

As shown in FIG. 5, the dental skill training device 20 according to the second modification of the first embodiment has a configuration in which the force sensor 24 is removed from the configuration of the dental skill training device 20 of the first embodiment.

According to the dental skill training device 20 of the second modification of the first embodiment, the same operations and effects as those of the dental skill training device 20 of the first embodiment are achieved except for the detection of the force applied to the tooth model 21.

### Third Modification of First Embodiment

Next, a dental skill training device according to a third modification of the first embodiment will be described. The dental skill training device according to the third modification of the first embodiment is different from the dental skill training device according to the first embodiment in that the force sensor is not provided and that a part of the surface of the gum has conductivity. Hereinafter, the difference will be mainly described. In the description of the third modification of the first embodiment, the same reference numerals as those used in the first embodiment are the same or substantially the same.

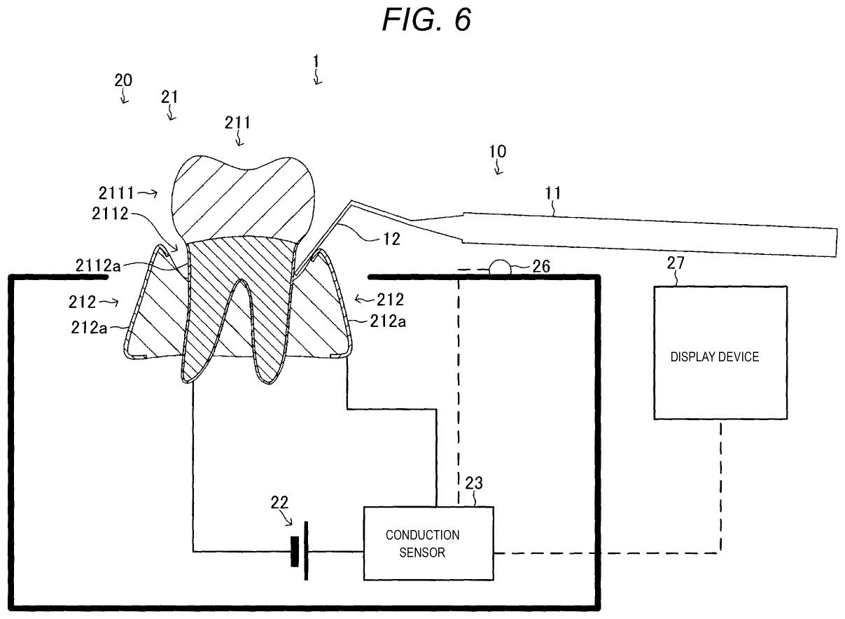

As shown in FIG. 6, the dental skill training device 20 according to the third modification of the first embodiment has a configuration in which the force sensor 24 and the connector 25 are removed from the configuration of the dental skill training device 20 of the first embodiment.

Further, the gum 212 of the tooth model 21 included in the dental skill training device 20 according to the third modification of the first embodiment has a conductive film 212a. The conductive film 212a is made of a conductive material. In this example, the conductive film 212a is made of a conductive coating material. For example, the conductive film 212a may be formed by coating using a spray.

For example, the conductive coating material may be a dispersion type in which a conductive additive (in other words, a filler) is dispersed in a coating material containing a resin as a main component, or may be an intrinsic type formed of a coating material containing a conductive polymer as a main component.

The conductive film 212a constitutes a surface of a portion of the gum 212 other than the vicinity of the bottom of the periodontal pocket (in this example, a portion in the vicinity of the protrusion).

A portion of the gum 212 other than the vicinity of the bottom of the periodontal pocket may be made of a conductive material (for example, a conductive resin). In this case, the gum 212 may not include the conductive film 212a.

The conductive film 212a is electrically connected to the conduction sensor 23.

With such a configuration, the electric circuit becomes the closed circuit in a state where the needle portion 12 of the periodontal probe 10 is in contact with both the conductive film 2112a of the tooth root portion 2112 and the conductive film 212a of the gum 212. In this example, the electric circuit is formed by electrically connecting the conductive film 212a of the gum 212, the needle portion 12 of the periodontal probe 10, the conductive film 2112a of the tooth root portion 2112, the DC voltage source 22, and the conduction sensor 23. Accordingly, a current flows through the conduction sensor 23. In this manner, the dental skill training device 20 detects the contact between the detection region and the needle portion 12 by detecting the conduction between the detection region and the needle portion 12.

On the other hand, the electric circuit becomes the open circuit in a state where the needle portion 12 of the periodontal probe 10 is separated from at least one of the conductive film 2112a of the tooth root portion 2112 and the conductive film 212a of the gum 212. Accordingly, no current flows through the conduction sensor 23.

In this example, the conductive film 212a of the gum 212, the conductive film 2112a of the tooth root portion 2112, the DC voltage source 22, and the conduction sensor 23 correspond to the contact detection unit.

In this example, the conduction sensor 23 supplies current to the light source 26 when a current flows through the conduction sensor 23, and does not supply a current to the light source 26 when no current flows through the conduction sensor 23.

As described above, according to the dental skill training device 20 of the third modification of the first embodiment, the same operations and effects as those of the dental skill training device 20 of the first embodiment are achieved except for the detection of the force applied to the tooth model 21.

Further, according to the dental skill training device 20 of the third modification of the first embodiment, since the connector 25 is not attached to the needle instrument (in this example, the periodontal probe 10), it is possible to allow the user to be trained while using a needle instrument that is actually used in the dentistry as it is.

The dental skill training device 20 according to the third modification of the first embodiment may include the force sensor 24, similarly to the dental skill training device 20 according to the first embodiment.

### Second Embodiment

Next, a dental skill training device of a second embodiment will be described. The dental skill training device of the second embodiment is different from the dental skill training device of the first embodiment in that the contact is detected using a capacitance method. Hereinafter, the difference will be mainly described. In the description of the second embodiment, the same reference numerals as those used in the first embodiment are the same or substantially the same.

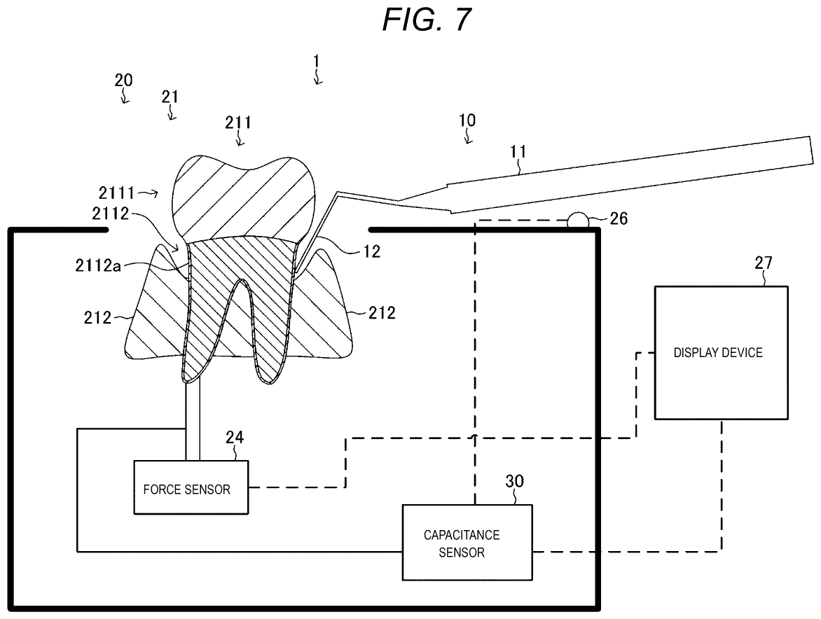

As shown in FIG. 7, the dental skill training device 20 of the second embodiment has a configuration in which the DC voltage source 22, the conduction sensor 23, and the connector 25 are removed from the configuration of the dental skill training device 20 of the first embodiment. Further, the dental skill training device 20 of the second embodiment includes a capacitance sensor 30.

The capacitance sensor 30 is electrically connected to the conductive film 2112a. The capacitance sensor 30 detects a capacitance of the conductive film 2112a. The capacitance sensor 30 detects the contact between the needle portion 12 and the detection region (in the present example, the conductive film 2112a) based on a change in the detected capacitance. In other words, the capacitance sensor 30 detects the contact between the needle portion 12 and the detection region using the capacitance method.

In this example, the conductive film 2112a and the capacitance sensor 30 correspond to the contact detection unit.

In the present example, the capacitance sensor 30 supplies a current to the light source 26 when the contact between the needle portion 12 and the detection region is detected, and does not supply a current to the light source 26 when the contact between the needle portion 12 and the detection region is not detected.

In addition, the capacitance sensor 30 outputs contact information indicating whether the contact between the needle portion 12 and the detection region is detected to the display device 27. The display device 27 displays the contact information output by the capacitance sensor 30 on the display.

In this example, the user holds the holding portion 11 of the periodontal probe 10 with bare hands without wearing gloves.

As described above, according to the dental skill training device 20 of the second embodiment, the same operations and effects as those of the dental skill training device 20 of the first embodiment are achieved.

Further, in the dental skill training device 20 of the second embodiment, the contact detection unit detects the contact between the needle portion 12 and the detection region using the capacitance method.

According to this, it is possible to easily detect the contact between the needle portion 12 of the needle instrument and the detection region of the surface of the tooth 211. In addition, since the connector 25 is not attached to the needle instrument (in this example, the periodontal probe 10), it is possible to allow the user to be trained while using a needle instrument that is actually used in the dentistry as it is.

Similarly to the dental skill training device 20 according to the first modification of the first embodiment, the dental skill training device 20 of the second embodiment may also include the imaging unit that images the imaging region including the boundary between the crown portion 2111 and the tooth root portion 2112 on the surface of the tooth 211.

The disclosure is not limited to the above-described embodiments. For example, various modifications that can be understood by those skilled in the art may be made to the above-described embodiments without departing from the spirit of the disclosure.

What is claimed is:

1. A dental skill training device that trains a skill in using a needle instrument in dentistry, the needle instrument including a holding portion to be held by a user and a needle-shaped needle portion extending from a tip of the holding portion, the dental skill training device comprising:
a tooth model simulating at least one tooth; and
a contact detector configured to detect contact between the needle portion and a predetermined detection region of at least a part of a surface of the tooth.

2. The dental skill training device according to claim 1, wherein
the detection region and the needle portion have electrical conductivity, and
the contact detector detects the contact by detecting conduction between the detection region and the needle portion.

3. The dental skill training device according to claim 2, wherein
the detection region is a surface of a tooth root portion of the tooth, and
a portion of the surface of the tooth other than the detection region does not have electrical conductivity.

4. The dental skill training device according to claim 2, wherein
a surface of a portion of the needle portion other than a tip portion does not have electrical conductivity.

5. The dental skill training device according to claim 1, wherein
the contact detector detects the contact using a capacitance method.

6. The dental skill training device according to claim 1, further comprising:
a force detector configured to detect a force applied to the tooth model.

7. The dental skill training device according to claim 1, further comprising:
notification processor circuitry configured to emit at least one of a sound and light when the contact is detected.

8. The dental skill training device according to claim 1, further comprising:
imaging processor circuitry configured to image an imaging region including a boundary between a crown portion and a tooth root portion on the surface of the tooth.

9. The dental skill training device according to claim 3, wherein
a surface of a portion of the needle portion other than a tip portion does not have electrical conductivity.

10. The dental skill training device according to claim 2, further comprising:
a force detector configured to detect a force applied to the tooth model.

11. The dental skill training device according to claim 5, further comprising:
a force detector configured to detect a force applied to the tooth model.

12. The dental skill training device according to claim 2, further comprising:
notification processor circuitry configured to emit at least one of a sound and light when the contact is detected.

13. The dental skill training device according to claim 5, further comprising:
notification processor circuitry configured to emit at least one of a sound and light when the contact is detected.

14. The dental skill training device according to claim 2, further comprising:
imaging processor circuitry configured to image an imaging region including a boundary between a crown portion and a tooth root portion on the surface of the tooth.

15. The dental skill training device according to claim 5, further comprising:
imaging processor circuitry configured to image an imaging region including a boundary between a crown portion and a tooth root portion on the surface of the tooth.

16. A dental skill training device that trains a skill in using a needle instrument in dentistry, the needle instrument including a holding portion to be held by a user and a needle-shaped needle portion extending from a tip of the holding portion, the dental skill training device comprising:
a tooth model simulating at least one tooth; and
a contact detection unit configured to detect contact between the needle portion and a predetermined detection region of at least a part of a surface of the tooth.

17. The dental skill training device according to claim 16, further comprising:
a force detection unit configured to detect a force applied to the tooth model.

18. The dental skill training device according to claim 16, further comprising:
a notification unit configured to emit at least one of a sound and light when the contact is detected.

19. The dental skill training device according to claim 16, further comprising:
an imaging unit configured to image an imaging region including a boundary between a crown portion and a tooth root portion on the surface of the tooth.
